(19) United States
(12) Patent Application Publication
(10) Pub. No.: US 2026/0326641 A1
(43) Pub. Date: Oct. 22, 2026

(54) ENERGY HARVESTING DEVICE

(71) Applicants: Hyundai Motor Company, Seoul (KR); Kia Corporation, Seoul (KR)

(72) Inventors: Baek Hee Lee, Hwaseong (KR); Min Hyuk Kwak, Hwaseong (KR); Yo Seob Lee, Hwaseong (KR); Kang Yen Lee, Hwaseong (KR); Won Seok Lee, Hwaseong (KR); Soong Un Choi, Hwaseong (KR); Dae Seon Lee, Hwaseong (KR); Sang Ji Moon, Hwaseong (KR)

(21) Appl. No.: 19/318,051

(22) Filed: Sep. 3, 2025

(30) Foreign Application Priority Data
Apr. 22, 2025 (KR) 10-2025-0052006

(51) Int. Cl. B60N 2/90; B60N 2/24; B60N 2/64; F03G 7/00

(52) U.S. Cl. CPC B60N 2/90; B60N 2/24; B60N 2/64; F03G 7/008; F03G 7/0252; F03G 7/027; F05B 2210/11; F05B 2260/406; F05B 2270/506; F05B 2270/602

(57) ABSTRACT

Provided is an energy harvesting device having a structure in which a hydraulic motor, a generator and the like configured to generate electrical energy, as well as a plurality of bladders filling a fluid in the bladders in an inflowable and outflowable manner, are built into a vehicle seat, allowing the fluid discharged from the bladders due to the body pressure of a person seated in the seat during travelling of the vehicle to drive the hydraulic motor and allowing the rotational force of the hydraulic motor to drive the generator, thus obtaining electrical energy usable in the vehicle. The system captures otherwise wasted energy without affecting seating comfort.

### CROSS-REFERENCE TO RELATED APPLICATION

This application claims, under 35 U.S.C. §119(a), the benefit of Korean Patent Application No. 10-2025-0052006, filed on April 22, 2025, the entire contents of which are incorporated herein by reference.

### BACKGROUND

### TECHNICAL FIELD

The present disclosure relates generally to an energy harvesting device, and more particularly, to an energy harvesting device built into a vehicle seat.

### BACKGROUND

Energy harvesting is a technology that harvests energy generated from natural energy sources, such as sunlight, waste heat, vibration, electromagnetic waves, and gravity, that would otherwise be discarded, converts the energy into electrical energy, and then stores that electrical energy for later use.

Because it typically obtains electricity from repeatedly generated heat and/or vibration, energy harvesting is regarded as an eco-friendly, renewable-energy technology.

Nevertheless, there remains a need for an energy harvesting device capable of obtaining electrical energy from vibrations generated while a vehicle is traveling, so that the harvested energy can be used to charge a battery and to power electrical components of an eco-friendly vehicle, such as a hybrid or electric vehicle.

The above information disclosed in this Background section is only for enhancement of understanding of the background of the present disclosure, and therefore it may contain information that does not form the related art that is already known to a person of ordinary skill in the art.

### SUMMARY OF THE DISCLOSURE

The present disclosure has been made in an effort to solve the above-described problems associated with the related art, and various embodiments of the present disclosure are directed to providing an energy harvesting device having a structure in which a hydraulic motor, a generator and the like configured to generate electrical energy, as well as a plurality of bladders filling a fluid in the bladders in an inflowable and outflowable manner, are built into a vehicle seat, allowing the fluid discharged from the bladders due to the body pressure of a person seated in the seat during travelling of the vehicle to drive the hydraulic motor and allowing the rotational force of the hydraulic motor to drive the generator, thus obtaining electrical energy usable in the vehicle.

In some embodiments, the present disclosure provides an energy harvesting device including a plurality of bladders built into a seatback and a seat cushion of a seat and filling a fluid in the bladders in an inflowable and outflowable manner, a fluid circulation line connected to the bladders in a fluid circulatable manner, a hydraulic motor mounted on the fluid circulation line, and a generator connected to a rotation shaft of the hydraulic motor.

A pressure applied to the bladder due to the change in body pressure of a user seated in the seat may discharge a fluid from the bladder to the fluid circulation line, and the fluid may pass through the hydraulic motor to transmit the rotational force of the hydraulic motor to the generator, allowing the generator to perform power generation operation.

The energy harvesting device may further include a battery charged with electrical energy generated by the power generation operation of the generator.

The plurality of bladders may be pressibly mounted between a seat cover of the seat and a foam pad.

The plurality of bladders each may form an outlet configured to discharge a fluid to the fluid circulation line and an inlet configured to receive the fluid from the fluid circulation line.

The plurality of bladders may include a first bladder built into a left bolster of the seatback and connected to the fluid circulation line in a fluid circulatable manner, a second bladder built into a right bolster of the seatback and connected to the fluid circulation line in a fluid circulatable manner, and a third bladder built into the seat cushion and connected to the fluid circulation line in a fluid circulatable manner.

The third bladder may be built into an area of the seat cushion where a user's body pressure is applied in response to the user operating an accelerator pedal and a brake pedal.

The fluid circulation line may include a fluid discharge line connected to an outlet of the first bladder, an outlet of the second bladder, and an outlet of the third bladder via a corresponding one of hydraulic hoses, a fluid return line connected to an inlet of the first bladder, an inlet of the second bladder, and an inlet of the third bladder via a corresponding one of hydraulic hoses, and a fluid passage line connected between the fluid discharge line and the fluid return line, wherein the hydraulic motor is mounted on the fluid passage line.

A three-way check valve configured to be opened to allow a flow of fluid discharged from the first bladder or to allow a flow of fluid discharged from the second bladder may be mounted on the fluid discharge line connected to the first bladder and on the fluid discharge line connected to the second bladder.

A first two-way check valve configured to guide the fluid discharged from the first bladder or the fluid discharged from the second bladder to flow into the fluid passage line may be mounted at an outlet portion of the three-way check valve.

A second two-way check valve configured to guide the fluid discharged from the third bladder to flow into the fluid passage line may be mounted on the fluid discharge line connected to the third bladder.

A nozzle configured to increase the flow rate of a fluid flowing to the hydraulic motor may be mounted at a front end portion of the fluid passage line.

An accumulator configured to store a portion of a pressure of the fluid may be connected to the fluid passage line disposed between the nozzle and the hydraulic motor.

A solenoid valve configured to be opened or closed based on a control signal of a controller to allow or block the flow of a fluid flowing to the hydraulic motor may be mounted on the fluid passage line.

In response to determining that a battery is fully charged based on a signal from a sensor configured to detect a charged power of the battery, the controller may be configured to close the solenoid valve to block the flow of the fluid.

In some embodiments, an energy-harvesting device for a vehicle seat is provided. The device includes a first bladder disposed in a left bolster of a seatback; a second bladder disposed in a right bolster of the seatback; a third bladder disposed in a seat cushion of the seat and located in an area to which a user’s body pressure is applied during acceleration or braking of the vehicle, each of the first, second, and third bladders being configured to be inflated with and to discharge a working fluid; a fluid discharge line connected to respective outlets of the first, second, and third bladders; a fluid passage line fluidly connecting the fluid discharge line to the fluid return line; a hydraulic motor mounted in the fluid passage line; a generator mechanically coupled to a rotation shaft of the hydraulic motor; and a nozzle disposed upstream of the hydraulic motor on the fluid passage line and configured to increase a flow rate of the working fluid supplied to the hydraulic motor.

The energy harvesting device may further include a three-way check valve mounted in the fluid discharge line and configured selectively to permit fluid discharged from the first bladder or the second bladder to enter the fluid passage line.

The energy harvesting device may further include (i) a first two-way check valve mounted downstream of the three-way check valve and configured to direct fluid from the first and or second bladder into the fluid passage line and (ii) a second two-way check valve mounted on a portion of the fluid discharge line connected to the third bladder and configured to direct fluid from the third bladder into the fluid passage line.

The energy harvesting device may further include an accumulator connected to the fluid passage line between the nozzle and the hydraulic motor, the accumulator being configured to store pressure energy of the working fluid.

The energy harvesting device may further include a solenoid valve mounted on the fluid passage line and a controller configured to close the solenoid valve to block fluid flow to the hydraulic motor when a battery electrically coupled to the generator is determined to be fully charged.

As discussed, the method and system suitably include use of a controller or processer.

In another embodiment, vehicles are provided that comprise an apparatus as disclosed herein.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to various embodiments thereof illustrated in the accompanying drawings which are given herein below by way of illustration only, and thus are not limitative of the present disclosure, and wherein:

FIG. 1 is a perspective view illustrating a plurality of bladders included in an energy harvesting device according to some embodiments of the present disclosure is built into a vehicle seat;

FIG. 2 is a cross-sectional view taken along line A-A of FIG. 1;

FIG. 3 is a cross-sectional view illustrating a state in which an energy harvesting device according to some embodiments of the present disclosure is built into a seat;

FIG. 4 is a cross-sectional view illustrating a state in which power is generated by a fluid flow when a first bladder and a third bladder of an energy harvesting device according to some embodiments of the present disclosure are pressurized;

FIG. 5 is a cross-sectional view illustrating a state in which power is generated by a flow of fluid when a second bladder and a third bladder of an energy harvesting device according to some embodiments of the present disclosure are pressurized; and

FIG. 6 is a cross-sectional view illustrating an operating state of an energy harvesting device according to some embodiments of the present disclosure when a battery is fully charged.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of various embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise. The terms “comprises” and/or “comprising” used in this specification mean that the cited component, step, operation, and/or element does not exclude the presence or addition of one or more of other components, steps, operations, and/or elements.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. As used herein, the term "and/or" includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, various embodiments of the present disclosure are described in detail with reference to the attached drawings.

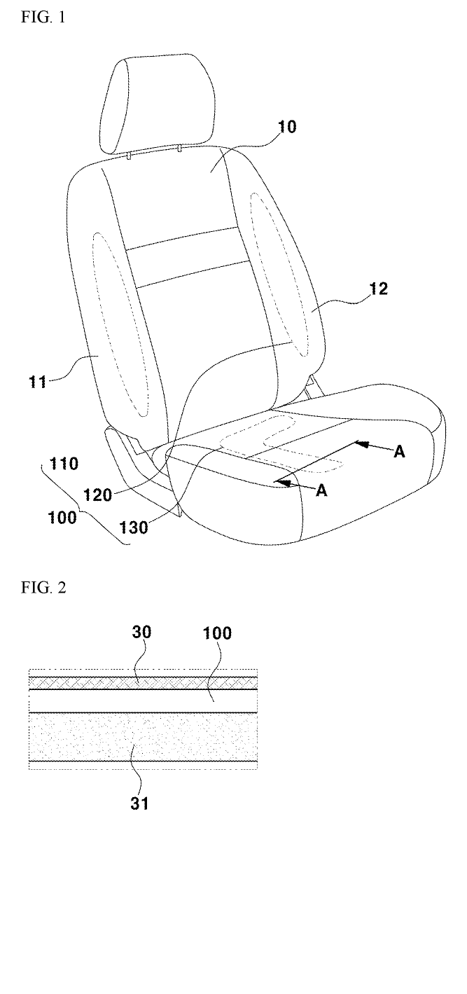

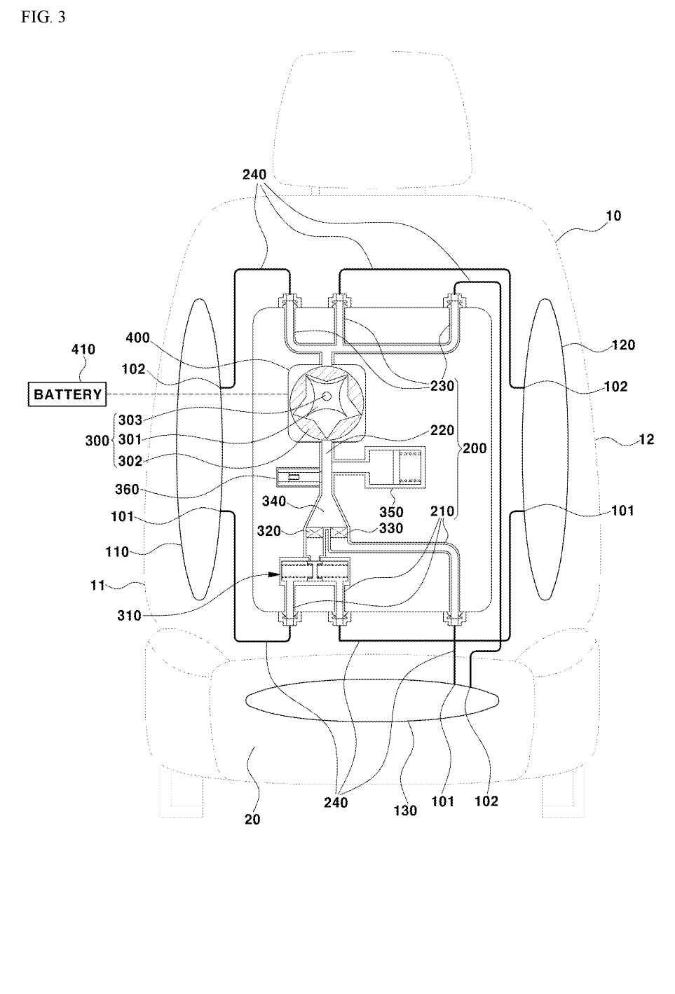

FIG. 1 and FIG. 2 illustrate a plurality of bladders included in an energy harvesting device according to the present disclosure is built into a vehicle seat, and FIG. 3 is a cross-sectional view illustrating a state in which the energy harvesting device according to the present disclosure is built into the seat.

As illustrated in FIG. 1, a vehicle seat includes a seatback 10 and a seat cushion 20. The seatback 10 has opposite side portions provided with a left bolster 11 and a right bolster 12, respectively, configured to support opposite sides of a passenger's upper body.

A plurality of bladders 100 is arranged inside the left bolster 11 and the right bolster 12 of the seatback 10 and inside the seat cushion 20, wherein the plurality of bladders 100 fills a fluid in the bladders 100 in an inflowable and outflowable manner.

To this end, each of the bladders 100 may form an outlet 101 configured to discharge a fluid to a fluid circulation line 200 and an inlet 102 configured to receive the fluid discharged to the fluid circulation line 200.

Here, so as to allow a passenger's body pressure to be easily transmitted to the plurality of bladders 100, each of the bladders 100 may be pressibly mounted between a seat cover 30 and a foam pad 31.

According to an embodiment of the present disclosure, the plurality of bladders 100 may include a first bladder 110 built into the left bolster 11 of the seatback 10 and connected to the fluid circulation line 200 in a fluid circulatable manner, a second bladder 120 built into the right bolster 12 of the seatback 10 and connected to the fluid circulation line 200 in a fluid circulatable manner, and a third bladder 130 built into the seat cushion 20 and connected to the fluid circulation line 200 in a fluid circulatable manner.

Accordingly, when the first bladder 110 built into the left bolster 11 of the seatback 10 is pressurized by the pressure of the passenger's body (e.g., one side of the upper body), a fluid is discharged from the first bladder 110 to the fluid circulation line 200, and the fluid discharged to the fluid circulation line 200 may be returned to the first bladder 110.

Moreover, when the second bladder 120 built into the right bolster 12 of the seatback 10 is pressurized by the pressure of the passenger's body (e.g., the other side of the upper body), a fluid is discharged from the second bladder 120 to the fluid circulation line 200, and the fluid discharged to the fluid circulation line 200 may be returned to the second bladder 120.

Here, the third bladder 130 may be built into an area of the seat cushion 20 where the user's buttocks touch and where the pressure of the user's body (e.g., upper legs) is applied in response to the user operating an accelerator pedal and a brake pedal.

Accordingly, when the third bladder 130 built into the seat cushion 20 is pressurized by the pressure of the body (e.g., upper legs) in response to the user operating the accelerator pedal and the brake pedal, a fluid is discharged from the third bladder 130 to the fluid circulation line 200, and the fluid discharged to the fluid circulation line 200 may be returned to the third bladder 130.

As illustrated in FIG. 3, the fluid circulation line 200 may include a fluid discharge line 210 connected to the outlet of the first bladder 110, the outlet of the second bladder 120, and the outlet of the third bladder 130 via a corresponding one of hydraulic hoses 240, a fluid return line 230 connected to the inlet of the first bladder 110, the inlet of the second bladder 120, and the inlet of the third bladder 130 via a corresponding one of hydraulic hoses 240, and a fluid passage line 220 connected between the fluid discharge line 210 and the fluid return line 230.

Particularly, a hydraulic motor 300 configured to output a rotational force by the flow of fluid is mounted at a predetermined position of the fluid passage line 220.

For example, the hydraulic motor 300 may include a case 301 in which an inlet and outlet for a fluid are formed, and a rotary 302 rotatably arranged inside the case 301. Here, a rotation shaft 303 of the rotary 302 may extend outwardly of the case 301 and be connected to a generator 400.

The generator 400 connected to the rotation shaft 303 of the hydraulic motor 300 may be operated to generate power by the rotational force transmitted from the hydraulic motor 300.

Accordingly, when the pressure applied to each of the bladders 100 due to the change in body pressure of the user seated in the seat discharges the fluid from the bladders 100 to the fluid circulation line 200 and the fluid passes through the hydraulic motor 300 to rotate the hydraulic motor 300, the rotational force of the hydraulic motor 300 is transmitted to the generator 400, allowing the generator 400 to perform power generation.

In further detail, when the fluid discharged from the bladder 100 by the pressure applied to each of the bladders 100 due to the change in body pressure of the user seated in the seat passes through the case 301 of the hydraulic motor 300 along the fluid passage line 220 and rotates the rotary 302, the rotational force is transmitted from the rotary shaft 303 of the rotary 302 to the generator 400, operating the generator 400 to generate electrical energy.

Here, a battery 410, which is a kind of auxiliary battery, is chargeably connected to the generator 400, and thus the battery 410 may be charged with the electrical energy generated by the power generation operation of the generator 400.

Meanwhile, a three-way check valve 310 configured to be opened to allow the flow of fluid discharged from the first bladder 110 or to allow the flow of fluid discharged from the second bladder 120 is mounted on the fluid discharge line 210 connected to the first bladder 110 and on the fluid discharge line 210 connected to the second bladder 120.

The three-way check valve 310 may include, as illustrated in FIG. 3, a valve body 311 having one side at which a first inlet port 311-1 to which the fluid discharge line 210 connected to the first bladder 110 is fastened and a second inlet port 311-2 to which the fluid discharge line 210 connected to the second bladder 120 is fastened are formed and having another side at which a single discharge port 311-3 is formed, an opening and closing plate 312 configured to open and close the discharge port 311-3 by being arranged to be movable left and right within the valve body 311, and springs 313 compressible arranged at left and right sides of the opening and closing plate 312, respectively, within the valve body 311.

Moreover, at an outlet portion of the three-way check valve 310, i.e., at the discharge port 311-3, a first two-way check valve 320 configured to block the fluid discharged from the first bladder 110 and passing through the three-way check valve 310 or the fluid discharged from the second bladder 120 and passing through the three-way check valve 310 from flowing in reverse direction and to guide the fluid to flow into the fluid passage line 220 is mounted.

Accordingly, when the fluid discharged from the first bladder 110 to the fluid discharge line 210 flows into the valve body 311 through the first inlet port 311-1 of the three-way check valve 310 and acts on one side portion of the opening and closing plate 312, the opening and closing plate 312 moves to one side to compress the spring 313, allowing the fluid flowing into the valve body 311 through the first inlet port 311-1 to pass through the first two-way check valve 320 via the discharge port 311-3 and then to flow into the fluid passage line 220.

Conversely, when the fluid discharged from the second bladder 120 to the fluid discharge line 210 flows into the valve body 311 through the second inlet port 311-2 of the three-way check valve 310 and acts on another side portion of the opening and closing plate 312, the opening and closing plate 312 moves to another side to compress the spring 313, allowing the fluid flowing into the valve body 311 through the second inlet port 311-2 to pass through the first two-way check valve 320 via the discharge port 311-3 and then to flow into the fluid passage line 220.

Moreover, at the fluid discharge line 210 connected to the third bladder 130, a second two-way check valve 330 configured to block the fluid discharged from the third bladder 130 from flowing in reverse direction and to guide the fluid to flow into the fluid passage line 220 is mounted.

Accordingly, the fluid discharged from the third bladder 130 to the fluid discharge line 210 may pass through the second two-way check valve 330 to flow into the fluid passage line 220.

Meanwhile, a nozzle 340 configured to increase the flow rate of the fluid flowing to the hydraulic motor 300 may be mounted at a front end portion of the fluid passage line 220.

Accordingly, when the fluid that has passed through the first two-way check valve 320 and the fluid that has passed through the second two-way check valve 330 pass through the nozzle 340, the flow rate of the fluid may increase, and by the fluid with the increased flow rate, the rotary 302 of the hydraulic motor 300 may be rotated more easily.

Moreover, an accumulator 350 configured to store a portion of the pressure of the fluid may be connected to the fluid passage line 220 disposed between the nozzle 340 and the hydraulic motor 300.

Accordingly, in a case where the pressure of the fluid flowing to the fluid passage line 220 excessively increases to or above a set value in response to the first bladder 110 and the third bladder 130 being pressurized at the same time or in response to the second bladder 120 and the third bladder 130 being pressurized at the same time, a portion of the pressure of the fluid may be stored in the accumulator 350, or in a case where the pressure of the fluid flowing through the fluid passage line 220 decreases below the set value, the fluid pressure stored in the accumulator 350 may be discharged to compensate for the increase in fluid pressure.

Here, a solenoid valve 360 configured to allow or block the flow of fluid flowing to the hydraulic motor 300 by being opened and closed based on a control signal of a controller 500 may further be mounted on the fluid passage line 220 disposed between an outlet of the nozzle 340 and the hydraulic motor 300.

Here, in response to determining that the battery 410 is fully charged to or above a reference value based on a signal from a sensor (not shown) configured to detect the charged power of the battery 410, the controller 500 is configured to close the solenoid valve 360 in order to block the fluid from flowing to the hydraulic motor 300.

Conversely, in response to determining that the battery 410 is charged below a reference value based on a signal from a sensor (not shown) configured to detect the charged power of the battery 410, the controller 500 is configured to open the solenoid valve 360 in order to allow the fluid to flow to the hydraulic motor 300.

Hereinafter, an operation flow of the energy harvesting device of the present disclosure performed based on the aforementioned configuration is described.

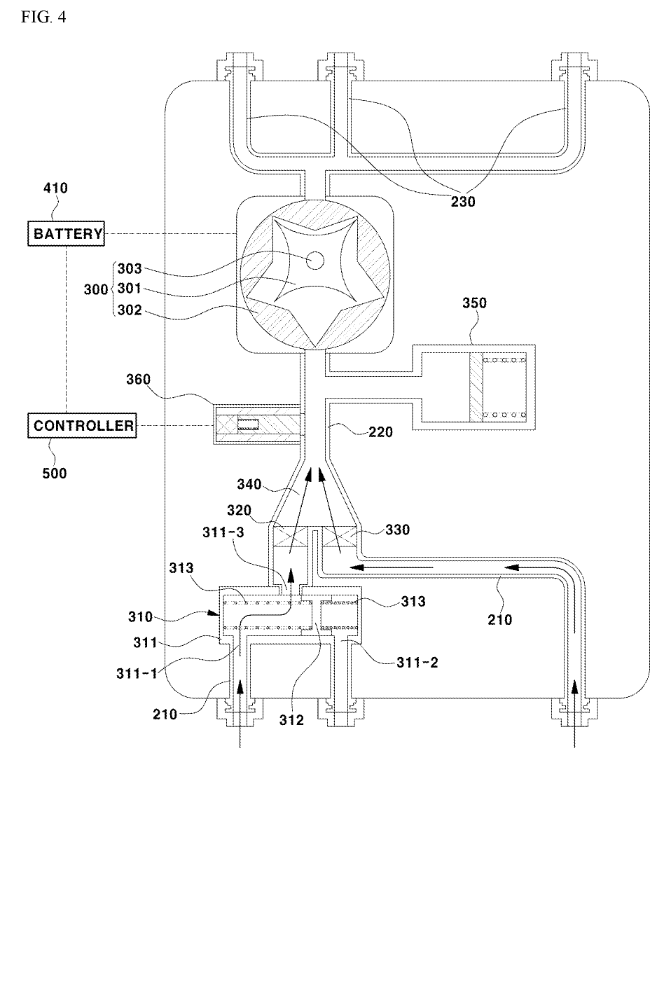

FIG. 4 is a cross-sectional view illustrating the state in which power is generated by the flow of the fluid when the first bladder and the third bladder of the energy harvesting device according to the present disclosure are pressurized.

When the first bladder 110 built into the left bolster 11 of the seatback 10 is pressurized by the body pressure of the person (e.g., one side of the upper body) seated in the seat, for example, when the driver's upper body is pushed to one side during the vehicle’s turn and the first bladder 110 is pressurized, the fluid is discharged from the first bladder 110 to the fluid discharge line 210 of the fluid circulation line 200 and is directed to the three-way check valve 310.

Thereafter, in response to the fluid discharged from the first bladder 110 to the fluid discharge line 210 flowing into the valve body 311 through the first inlet port 311-1 of the three-way check valve 310 and acting on one side portion of the opening and closing plate 312, the opening and closing plate 312 is moved to one side to compress the spring 313, allowing the fluid to be discharged to the discharge port 311-3 of the valve body 311 and then to flow to the fluid passage line 220 through the first two-way check valve 320.

Moreover, when the third bladder 130 built into the seat cushion 20 is pressurized by the pressure of the driver's body (e.g., upper legs) applied in response to the driver operating the accelerator pedal and the brake pedal, the fluid is discharged from the third bladder 130 to the fluid discharge line 210 to flow to the fluid passage line 220 through the second two-way check valve 330.

Here, in a case where the battery 410 is not fully charged, the solenoid valve 360 is kept to be open based on the control signal of the controller 500.

Next, as the fluid discharged from the first bladder 110 and passed through the first two-way check valve 320 and the fluid discharged from the third bladder 130 and passed through the second two-way check valve 330 pass through the nozzle 340 mounted on the fluid passage line 220, the flow rate of the fluid is increased.

Thereafter, as the fluid with increased flow rate passes through the hydraulic motor 300, the hydraulic motor 300 may be driven to rotate, and at the same time, the rotational force of the hydraulic motor 300 may be transmitted to the generator 400, operating the generator 400 to generate electricity.

In further detail, when the fluid with increased flow rate passes through the case 301 of the hydraulic motor 300 and rotates the rotary 302, the rotational force is transmitted from the rotation shaft 303 of the rotary 302 to the generator 400, and the generator 400 may perform power generation operation.

Accordingly, the battery 410 may be charged with electrical energy generated by the power generation operation of the generator 400.

Meanwhile, the fluid passing through the hydraulic motor 300 may be returned to the first bladder 110 and the third bladder 130 through the fluid return line 230 by the pumping force of the rotary 302 of the hydraulic motor 300.

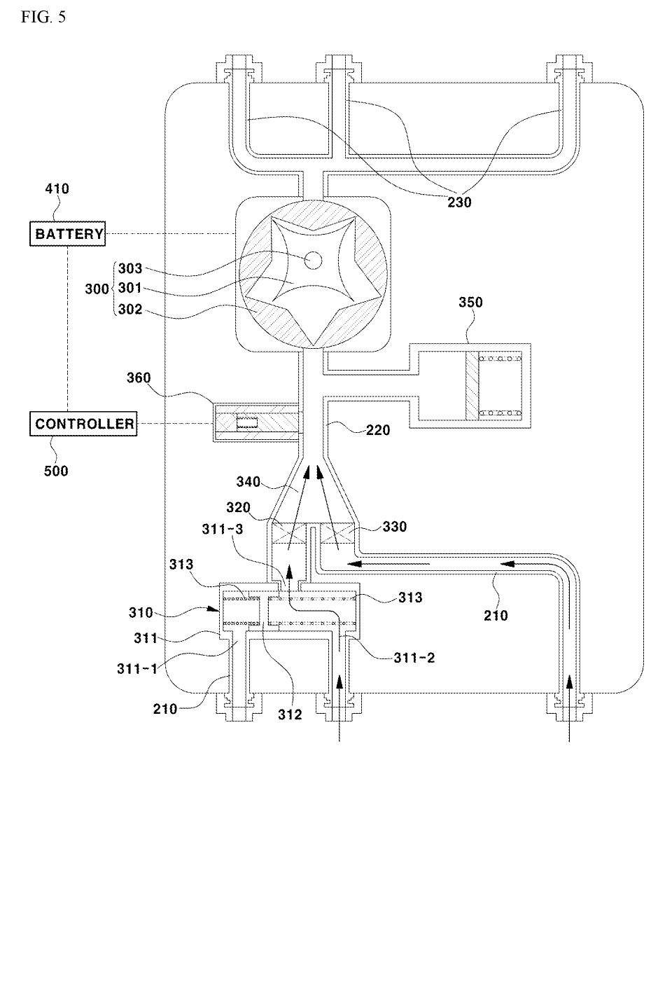

FIG. 5 is a cross-sectional view illustrating the state in which power is generated by the flow of the fluid when the second bladder and the third bladder of the energy harvesting device according to the present disclosure are pressurized.

When the second bladder 120 built into the right bolster 12 of the seatback 10 is pressurized by the body pressure of the person (e.g., the other side of the upper body) seated in the seat, for example, when the driver's upper body is pushed to the other side during the vehicle’s turn and the second bladder 110 is pressurized, the fluid is discharged from the second bladder 120 to the fluid discharge line 210 of the fluid circulation line 200 and is directed to the three-way check valve 310.

Thereafter, in response to the fluid discharged from the second bladder 120 to the fluid discharge line 210 flowing into the valve body 311 through the first inlet port 311-1 of the three-way check valve 310 and acting on the other side portion of the opening and closing plate 312, the opening and closing plate 312 is moved to the other side to compress the spring 313, allowing the fluid to be discharged to the discharge port 311-3 of the valve body 311 and then to flow to the fluid passage line 220 through the first two-way check valve 320.

Moreover, when the third bladder 130 built into the seat cushion 20 is pressurized by the pressure of the driver's body (e.g., upper legs) applied in response to the driver operating the accelerator pedal and the brake pedal, the fluid is discharged from the third bladder 130 to the fluid discharge line 210 to flow to the fluid passage line 220 through the second two-way check valve 330.

Here, in a case where the battery 410 is not fully charged, the solenoid valve 360 is kept to be open based on the control signal of the controller 500.

Next, as the fluid discharged from the second bladder 120 and passed through the first two-way check valve 320 and the fluid discharged from the third bladder 130 and passed through the second two-way check valve 330 pass through the nozzle 340 mounted on the fluid passage line 220, the flow rate of the fluid is increased.

Similarly, when the fluid with increased flow rate passes through the case 301 of the hydraulic motor 300 and rotates the rotary 302, the rotational force is transmitted from the rotation shaft 303 of the rotary 302 to the generator 400, allowing the generator 400 to perform power generation operation to generate electrical energy, and the battery 410 may be charged with the electrical energy generated by the power generation operation of the generator 400.

Meanwhile, the fluid passing through the hydraulic motor 300 may be returned to the second bladder 120 and the third bladder 130 through the fluid return line 230 by the pumping force of the rotary 302 of the hydraulic motor 300.

In this way, the electrical energy generated by the operation of the generator 400 is charged in a separate auxiliary battery 410 and may be easily used as power consumption of seat-related electric components (e.g., seat position adjustment motor, seat heating wire, seat ventilation blower, etc.) and charging power for smart devices and the like.

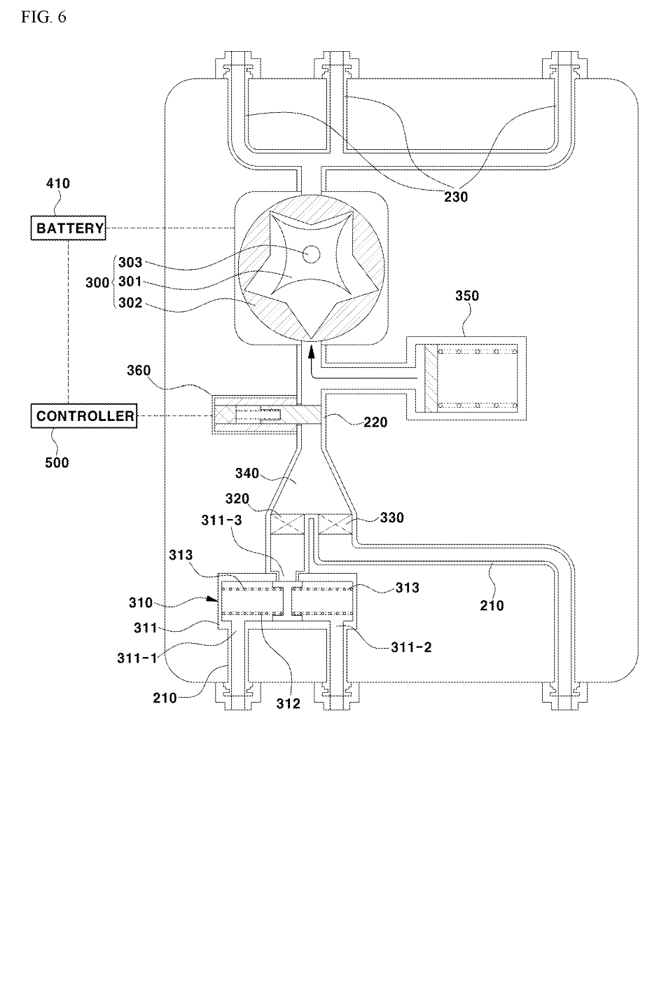

FIG. 6 is a cross-sectional view illustrating the operating state of the energy harvesting device according to the present disclosure when the battery is fully charged.

In response to determining that the battery 410 is fully charged to or above the reference value, that is, in response to determining, by the controller 500, that the battery 410 is fully charged to or above the reference value based on a signal from a sensor (not shown) configured to detect the charged power of the battery 410, the solenoid valve 360 may be controlled to be closed based on the control signal of the controller 500.

Accordingly, even when fluids are discharged from the first bladder 110, the second bladder 120 and the third bladder 130, the fluids do not flow to the hydraulic motor 300 due to the closing of the solenoid valve 360, thus stopping the power generation operation of the generator for charging the battery.

As is apparent from the above description, the present disclosure provides the following effects.

First, when the body pressure applied to the bolster of the seatback during high-speed travelling and turning of the vehicle and the body pressure applied to the seat cushion in response to the driver pressing the accelerator pedal and brake pedal act on the bladders built into the seat, the fluid discharged from the bladders drives the hydraulic motor, and the generator is driven by the rotational force of the hydraulic motor, obtaining electrical energy usable in the vehicle.

Second, the electrical energy generated by the operation of the generator may be charged in a separate auxiliary battery and may be used as power consumption of seat-related electric components (e.g., seat position adjustment motor, seat heating wire, seat ventilation blower, etc.) and charging power for smart devices and the like.

Although the present disclosure has been described in detail with reference to various embodiments, the scope of the present disclosure is not limited to the above-described embodiments, and various modifications and improvements by those skilled in the art based on the basic concept of the present disclosure as defined in the claims below will also be included in the scope of the present disclosure.

What is claimed is:

1. An energy harvesting device comprising:
a plurality of bladders built into a seatback and a seat cushion of a seat, the plurality of bladders being configured to be filled with a fluid in an inflowable and outflowable manner;
a fluid circulation line fluidly connected to the bladders;
a hydraulic motor disposed in the fluid circulation line; and
a generator operatively coupled to a rotation shaft of the hydraulic motor.

2. The energy harvesting device of claim 1, wherein pressure applied to the bladder, caused by a change in body pressure of a user seated in the seat, discharges the fluid from the bladder into the fluid circulation line, the discharged fluid passing through the hydraulic motor to transmit rotational force to the generator so that the generator performs power generation.

3. The energy harvesting device of claim 1, further comprising a battery configured to be charged with electrical energy generated by the power generation of the generator.

4. The energy harvesting device of claim 1, wherein the plurality of bladders is mounted between a seat cover of the seat and a foam pad.

5. The energy harvesting device of claim 1, wherein each of the plurality of bladders defines an outlet configured to discharge a fluid to the fluid circulation line and an inlet configured to receive the fluid from the fluid circulation line.

6. The energy harvesting device of claim 1, wherein the plurality of bladders comprises:
a first bladder built into a left bolster of the seatback and fluidly connected to the fluid circulation line;
a second bladder built into a right bolster of the seatback and fluidly connected to the fluid circulation line; and
a third bladder built into the seat cushion and fluidly connected to the fluid circulation line.

7. The energy harvesting device of claim 6, wherein the third bladder is disposed in an area of the seat cushion where a user's body pressure is applied when the user operates an accelerator pedal and a brake pedal.

8. The energy harvesting device of claim 6, wherein the fluid circulation line comprises:
a fluid discharge line connected to respective outlets of the first, second, and third bladders through respective hydraulic hoses;
a fluid return line connected to respective inlets of the first, second, and third bladders through respective hydraulic hoses; and
a fluid passage line connected between the fluid discharge line and the fluid return line, the hydraulic motor being disposed on the fluid passage line.

9. The energy harvesting device of claim 8, wherein a three-way check valve configured to permit a flow of fluid discharged from either the first bladder or the second bladder is mounted on the fluid discharge line connected to the first bladder and second bladders.

10. The energy harvesting device of claim 9, wherein a first two-way check valve configured to direct the fluid discharged from the first bladder or the second bladder into the fluid passage line is mounted at an outlet portion of the three-way check valve.

11. The energy harvesting device of claim 8, wherein a second two-way check valve configured to direct the fluid discharged from the third bladder into the fluid passage line is mounted on the fluid discharge line connected to the third bladder.

12. The energy harvesting device of claim 8, further comprising a nozzle mounted at an upstream end of the fluid passage line and configured to increase a flow rate of the fluid flowing toward the hydraulic motor.

13. The energy harvesting device of claim 12, further comprising an accumulator connected to the fluid passage line between the nozzle and the hydraulic motor, the accumulator being configured to store a portion of pressure of the fluid.

14. The energy harvesting device of claim 8, further comprising a solenoid valve mounted on the fluid passage line and configured to be opened or closed in response to a control signal from a controller to selectively allow or block fluid flow to the hydraulic motor.

15. The energy harvesting device of claim 14, wherein, in response to determining that a battery is fully charged based on a signal from a sensor configured to detect a charged power of the battery, the controller is configured to close the solenoid valve to block the flow of the fluid.

16. An energy-harvesting device for a vehicle seat, the device comprising:
a first bladder disposed in a left bolster of a seatback;
a second bladder disposed in a right bolster of the seatback;
a third bladder disposed in a seat cushion of the seat and located in an area to which a user’s body pressure is applied during acceleration or braking of the vehicle, each of the first, second, and third bladders being configured to be inflated with and to discharge a working fluid;
a fluid discharge line connected to respective outlets of the first, second, and third bladders;
a fluid passage line fluidly connecting the fluid discharge line to the fluid return line;
a hydraulic motor mounted in the fluid passage line;
a generator mechanically coupled to a rotation shaft of the hydraulic motor; and
a nozzle disposed upstream of the hydraulic motor on the fluid passage line and configured to increase a flow rate of the working fluid supplied to the hydraulic motor.

17. The energy harvesting device of claim 16, further comprising a three-way check valve mounted in the fluid discharge line and configured selectively to permit fluid discharged from the first bladder or the second bladder to enter the fluid passage line.

18. The energy harvesting device of claim 17, further comprising (i) a first two-way check valve mounted downstream of the three-way check valve and configured to direct fluid from the first and or second bladder into the fluid passage line and (ii) a second two-way check valve mounted on a portion of the fluid discharge line connected to the third bladder and configured to direct fluid from the third bladder into the fluid passage line.

19. The energy harvesting device of claim 16, further comprising an accumulator connected to the fluid passage line between the nozzle and the hydraulic motor, the accumulator being configured to store pressure energy of the working fluid.

20. The energy harvesting device of claim 16, further comprising a solenoid valve mounted on the fluid passage line and a controller configured to close the solenoid valve to block fluid flow to the hydraulic motor when a battery electrically coupled to the generator is determined to be fully charged.
